(19) United States
(12) Patent Application Publication
(10) Pub. No.: US 2007/0008025 A1
(43) Pub. Date: Jan. 11, 2007

(54) Gate Clock Circuit and Related Method

(76) Inventor: Po-Yo Tseng, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,440

(22) Filed: Feb. 7, 2006

(30) Foreign Application Priority Data
Jul. 11, 2005 (TW) 094123408

(51) Int. Cl. G06F 1/04

(52) U.S. Cl. 327/291

(57) ABSTRACT

A gate clock circuit and related method for generating a gate clock signal according to a clock and an enable signal. The gate clock circuit includes a transmission unit for receiving an enable signal and a clock signal, a latch unit connected to the transmission unit for generating a latch signal, and an operation unit for processing a logic operation on the inverse of the clock signal and the latch signal to generate a gate clock signal.

### BACKGROUND OF THE INVENTION

1. Field of the Invention

The invention relates to a gate clock circuit and related method, and more particularly, to a simplified gate clock circuit with capable of preventing glitches.

2. Description of the Prior Art

Integrated circuits are one of the most important hardware bases in the information-oriented society. Integrated circuits use multiple functional blocks in order to implement various complicated functions, with each block implementing a fundamental function. For example, by enabling some blocks and disabling others selectively in different situations are capable of changing the operation mode of electronic circuits can be realized.

Generally speaking, each block in the integrated circuits is controlled by a corresponding enable signal. For example, if the enable signal of a block is logic high, the block is enabled to work. On the other hand, if the enable signal of the block is logic low, the block is disabled from working.

As is well known, using the clock to trigger the timing of each block can coordinate the operation of the whole integrated circuit. However, continually triggering a block when the block is disabled still consumes power. This is because the disable block suspends receiving and sending signals, some circuits of the block may still work cause of continually trigger of the clock. Thus power is consumed.

Clock gating is used to reduce power consumption by stopping the clock continually triggering the disable block in integrated circuits. Furthermore, the block is triggered by a gate clock, which is generated according to the block's enable signal and the original clock. The gate clock is in step with the original clock and triggers the block to work according the timing with periodical waveform when the block is enabled. And the gate clock withholds a fixed logic level, such as logic low, and does not trigger the block when the block is disable, so power is saved.

The conventional gate clock circuit uses a flip-flop and an AND gate to generate a gate clock signal according to an enable signal and a clock signal. The flip-flop receives the enable signal and generates an output signal when the clock signal sends a trigger. That is, the flip-flop samples the enable signal at the rising edge of the clock and maintains a fixed logic level of the output signal for a clock cycle until a next sampling. The AND gate processes a logic operation on the output signal and the clock signal to generate a gate clock signal.

However, after processing the AND logic operation, two adjacent cycles of the gate clock signal interfere with each other and produce a glitch due to the flip-flop maintaining the output signal at a fixed logic level for a clock cycle. The glitch influences the quality of the gate clock signal GCK and causes an error in the circuit. Furthermore, the size of the flip-flop is too large to dispose in the compact circuits because a flip-flop normally needs four logic gates and a plurality of MOSFET s between the logic gates.

### SUMMARY OF THE INVENTION

The invention provides a gate clock circuit with capable of preventing glitches and with simplified structure in order to solve the above-mentioned problems.

A gate clock circuit of the present invention includes a transmission unit, a latch unit, and an operation unit. The transmission unit receives an enable signal and a clock signal, the latch unit connected to the transmission unit generates a latch signal. And the operation unit processes a logic operation on the inverse of the clock signal and the latch signal to generate a gate clock signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a prior art gate clock circuit.

FIG. 2 is a diagram illustrating the signal waveform timing of the gate clock circuit in FIG. 1.

FIG. 3 is a block diagram of a gate clock circuit according to the present invention.

FIG. 4 is a diagram illustrating the signal waveform timing of the gate clock circuit in FIG. 3.

FIG. 5 is a truth table of the gate clock circuit in FIG. 3.

FIG. 6 is a diagram illustrating an application of the gate clock circuit according to the present invention.

### DETAILED DESCRIPTION

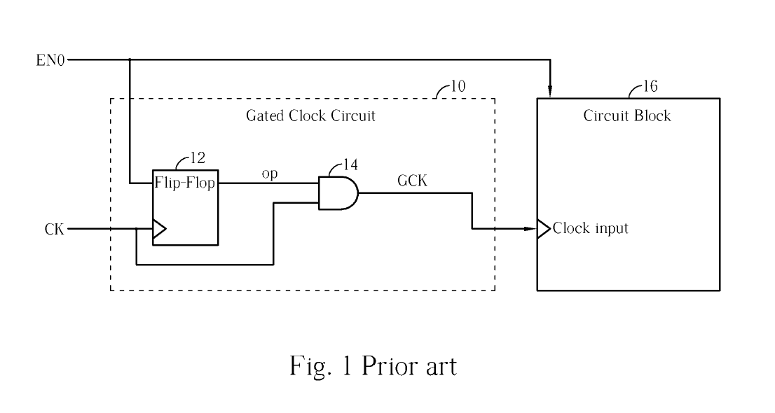

FIG. 1 is a block diagram of a conventional gate clock circuit 10 and a circuit block 16. The circuit block 16 is controlled by an enable signal EN0, and includes a clock terminal to accept the clock trigger. The gate clock circuit 10 generates a gate clock signal GCK according to the enable signal EN0 and a clock signal CK. The circuit block 16 is triggered by the gate clock signal GCK.

As shown in FIG. 1, the gate clock circuit 10 includes a flip-flop 12 (i.e. a D type filp-flop) and an AND gate 14. The flip-flop 12 receives the enable signal EN0, and then outputs an output signal op when the clock signal CK triggers. The AND gate 14 processes a logic operation of the output signal op and the clock signal CK to generate the gate clock signal GCK.

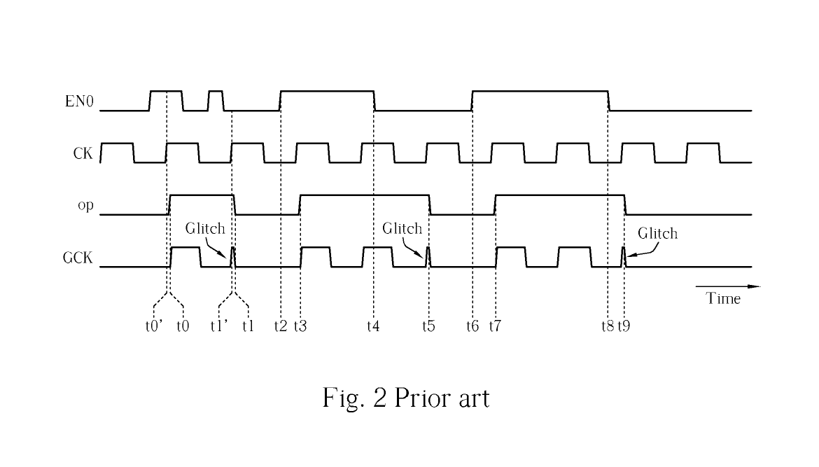

Please refer to FIG. 2 and FIG. 1. FIG. 2 is a diagram illustrating signal waveform timing of the gate clock circuit 10 in FIG. 1. The horizontal axis on FIG. 2 represents timing, and the vertical axis of each signal represents signal level (such as voltage level). As for the enable signal EN0, the circuit block 16 is active when the enable signal EN0 is logic high, and the circuit block 16 is inactive when the enable signal EN0 is logic low. The clock signal CK is a standard clock varying periodically.

The flip-flop 12 samples the enable signal EN0 at the rising edge of the clock signal CK and maintains a fixed logic state of the output signal op for a clock cycle until a next sampling. As shown in FIG. 2, at t0′, the flip-flop 12 samples the enable signal EN0 at the rising edge of the clock signal CK to logic high. After a time delay (at t0), the output signal op transits from logic low state to logic high state and maintains at high state for a clock cycle. At t1′, the flip-flop 12 samples the enable signal EN0 at the rising edge of the clock signal CK to logic low state. After a time delay (at t1), the output signal op transits from logic high state to logic low state.

In the other words, the enabled period of the enable signal EN0 forms a period of the output signal op synchronized with the clock cycle. As shown in FIG. 2, from t2 to t4, the enable signal EN0 is logic high state and makes two cycles of the output signal op at logic high state. That is, the output signal op maintains at logic high state during t3 to t5. The enabled period t6 to t8 of the enable signal EN0 makes two cycles of the output signal op maintains at logic high state during t7 to t9. Due to the period of the output signal op being simultaneous with the clock cycle, the gate clock signal GCK follows the enabled period and the disabled period to implement the purpose of clock gating. After the logic operation of the AND gate 14, the output signal op maintains two cycles in the gate clock signal GCK during t3 to t5 according to the enabled period t2 to t4 of the enable signal EN0. The output signal op maintains two cycles in the gate clock signal GCK during t7 to t9 according to the enabled period t6 to t8 of the enable signal EN0. Relatively, the output signal op disables a cycle in the gate clock signal GCK during t5 to t7 according to the disabled period t4 to t6 of the enable signal EN0.

However, there are glitches that occur while operating the gate clock circuit 10, especially when the output signal op switches from logic high state to logic low state. As shown in FIG. 2, when at t1′, the flip-flop 12 samples the enable signal EN0 at the rising edge of the clock signal CK to logic low state, but the output signal op takes a delay time to turnfrom logic high state to logic low state. During the delay time, the state of the clock signal CK is logic high causing a glitch in the gate clock signal GCK. Near t5 and t9, there are glitches in the gate clock signal GCK due to the output signal op does not restrain the clock signal CK during the mentioned delay time. The glitch influences the quality of the gate clock signal GCK and causes an error in the circuit.

A delay in the gate clock circuit 10 can be added to overcome the glitch. The clock signal CK can be delayed and sent to AND gate 14, and a logic operation can be processed on the delayed clock signal and the output signal op. As for the delayed clock signal, its rising edge avoids the transition of the output signal op thereby preventing glitches. However, the delayed clock signal needs a delay that wastes layout area and energy. The delayed clock signal also makes the gate clock delay and reduces the margin of timing control, which is not beneficial to high frequency clock applications or strict timing applications.

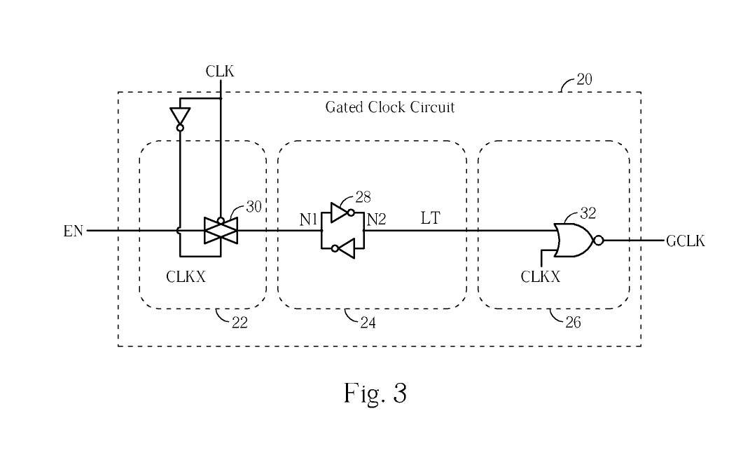

FIG. 3 is a block diagram of a gate clock circuit 20 according to an embodiment of the present invention. The gate clock circuit 20 generates a gate clock signal GCLK according to a clock signal CLK and an enable signal EN. The gate clock circuit 20 includes a transmission unit 22, a latch unit 24, and an operation unit 26. The transmission unit 22 is realized by a transmission gate 30, and determines whether or not to transmit the enable signal EN to the node N1 of the latch unit 24 according to the clock signal CLK and the inverse clock signal CLKX. The latch unit 24 is realized by two back-to-back inverters 28, and the signal of the latch unit 24 at the node N2 is a latch signal LT. The operation unit 26 includes a NOR gate 32. The NOR gate 32 processes a NOR logic operation on the inverse clock signal CLKX and the latch signal LT to generate a gate clock signal GCLK.

The operating process of the gate clock circuit 20 is described as follows. The transmission unit 22 transmits the enable signal EN to the node N1 of the latch unit 24 when the clock signal CLK is logic low state. The transmission unit 22 does not output the enable signal EN to the latch unit 24 when the clock signal CLK is logic high state. The latch signal LT at the node N2 follows the inverse of the enable signal EN when the transmission unit 22 transmits the enable signal EN. The latch signal LT maintains a fixed logic state when the transmission unit 22 stops transmitting the enable signal EN until a next time the clock signal CLK is logic low state. The NOR gate 32 processes a NOR logic operation on the inverse clock signal CLKX and the latch signal LT to generate the gate clock signal GCLK. When the latch signal LT maintains a fixed logic state, the operation unit 26 determines whether or not the gate clock signal GCLK follows the clock signal CLK according to the logic state of the latch signal LT. The latch signal LT is latched when the clock signal CLK maintains a high logic state (CLK=1) for half of the cycle. The gate clock signal GCLK follows the clock signal CLK if the latch signal LT is latched as logic low stata (LT=0). On the other hand, if the latch signal LT is latched as logic high state (LT=1), the operation unit 26 restrains the gate clock signal GCLK from being logic high.

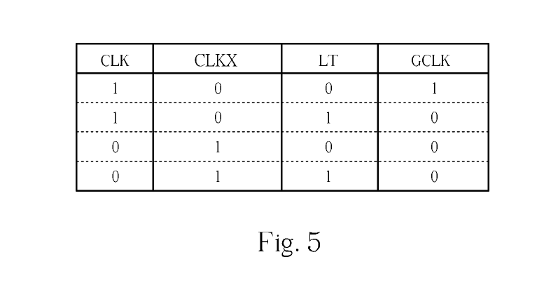

The operation situation of the components mentioned above is shown in FIG. 5. FIG. 5 is the truth table of the gate clock circuit 20 according to the present invention. The latch signal LT is latched when the clock signal CLK is logic high state (CLK=1). The gate clock signal GCLK follows the clock signal CLK if the latch signal LT is latched as logic low state (LT=0). When the latch signal LT is latched as logic high state (LT=1), the gate clock signal GCLK is restrained from being logic high (GCLK=0).

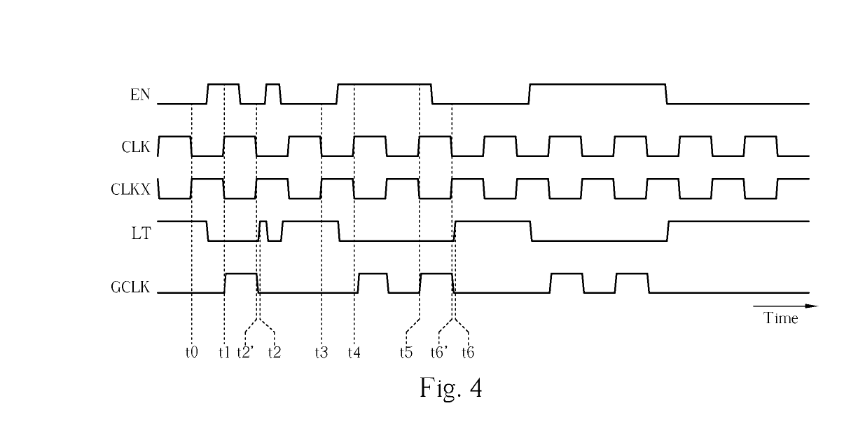

Please refer to FIG. 4 and FIG. 3. FIG. 4 shows a diagram illustrating the waveform timing of the gate clock circuit 20. The horizontal axis in FIG. 4 represents time, and the vertical axis of each signal represents the signal's state. As shown in FIG. 4, the duration of the enable signal EN being logic high state represents the enabled period, and the duration of the enable signal EN being logic low state represents the disabled period. The clock signal CLK is a standard clock that varies cyclically. When the clock signal CLK is logic low state, the latch signal LT follows the inverse of the enable signal EN. The clock signal CLK maintains a logic low state after t0, and then the latch signal LT follows the inverse of the enable signal EN. The clock signal CLK turns high state at t1 and the latch signal LT is latched as a fixed logic state at t1. In the example of FIG. 4, the state of the latch signal LT is logic low state at t1, so the latch signal LT is latched as logic low state after t1. The clock signal CLK turns low state at t2′, and then the latch signal LT follows the inverse of the enable signal EN from t2 until next time the clock signal CLK turns high state. In the case of FIG. 4, the enable signal EN is low state at t2′, so the latch signal LT turns high state to follow the inverse of the enable signal EN at t2. Whether to restrain the clock signal CLK or not to generate the gate clock signal GCLK is determined according to the state of the latch signal LT.

As mentioned above, due to the delay of the latch unit 24, the present invention prolongs the period of the latch signal LT keeping at a fixed logic state, and this period is long enough to contain half of a clock cycle (the duration when the clock signal CLK is logic high state). Therefore, the present invention is capable of preventing glitches.

In FIG. 2, the gate clock circuit 10 generates the gate clock signal GCK according to the output signal op. Glitches are formed because the switching timing of the output signal op overlaps the positive cycle of the clock signal CK. Compared with the prior art, the present invention generates the gate clock signal GCLK according to the latch signal LT. The latch signal LT switches states only when the clock signal CK is logic low state, so the switching timing of the output signal op does not overlap the positive cycle of the clock signal CK. The present invention is capable of preventing the gate clock signal GCLK from being interfered with by glitches.

Generally speaking, the timing of switching the enable signal's state from low state to high state happens when the clock signal is logic low state to maintain a fixed set-up time with the next rising clock. In the present invention, the latch signal LT follows the inverse of the enable signal EN when the clock signal CLK is logic low state. That is, the timing of switching the latch signal's state from high state to low state happens when the clock signal CLK is logic low state prior to the next positive cycle of the clock signal. In FIG. 4, the enable signal EN switches state from low state to high state between t0 and t1, and the latch signal LT switches state from high state to low state. At t2, the latch signal LT switching state from low state to high state represents that the latch signal LT follows the inverse of the enable signal EN. Due to the delay operation of the latch unit 24, the latch signal LT switches states only after the clock signal CLK has been logic low state. Therefore, the latch signal LT in the present invention only switches states when the clock signal CLK is logic low state thereby preventing glitches.

During the time of t3 to t4, the enable signal EN switches to logic high state and the latch signal LT switches to logic low state. During the time of t5 to t6, the enable signal EN switches to logic low state and the latch unit 24 latches the latch signal LT preventing it from being changed. The clock signal CLK switches to logic low state at the time t6′, and then the latch signal LT follows the high logic state of the inverse of the enable signal EN. Thus, both the rising and falling edges of the latch signal LT do not overlap with the high-level timing of the clock signal CLK, thereby preventing glitches.

Furthermore, the delay between the gate clock signal GCLK and the clock signal CLK is not too long and is suitable for circuits requiring critical timing. The present invention needs no delay and is easier to be realized than the prior art. In FIG. 1, the prior art circuit needs at least four logic gates. In comparison, the transmission unit, the latch unit, and the operation unit are basic elements and need smaller layout area. As shown in FIG. 3, the gate clock circuit 20 of the present invention needs only six pairs of CMOS (six P-MOS and six N-MOS) transistors.

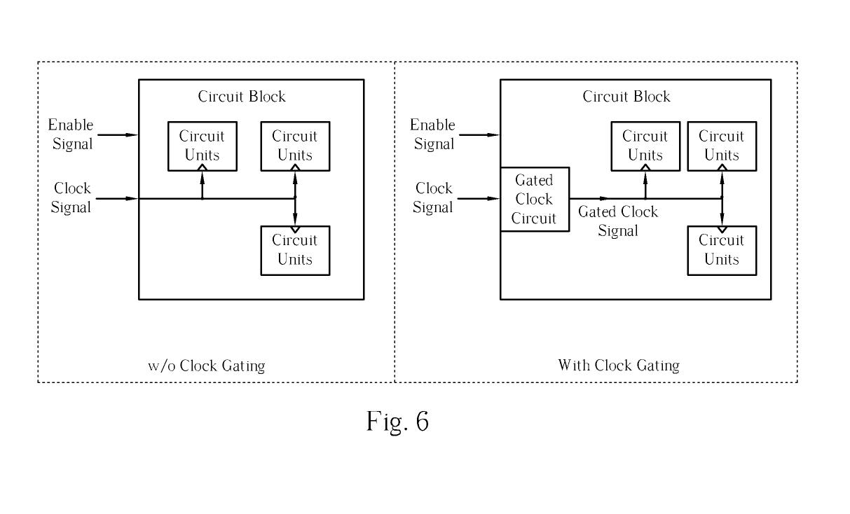

FIG. 6 is a diagram of an application according to the present invention. Elements of the circuit blocks without gate clock disabled by the enable signal still consume power because all elements are triggered by a cyclic clock signal. In order to reduce power consumption during the disabled period, a gate clock circuit is integrated into the circuit blocks. The gate clock signal used to trigger the circuit is generated according to the enable signal and the clock signal. The gate clock signal is identical to the original clock signal during the enabled period, and triggers circuit blocks to work with periodically logic state transitions. The logic state transition of the gate clock signal is restrained during the disabled period to prevent needless triggering of circuit elements that consumes power.

In summary, compared with the conventional gate clock circuits, the gate clock circuit of the present invention is capable of preventing glitches and is of simple layout. Furthermore, the gate clock circuit of the present invention has no delay. The transmission unit, the latch unit, and the operation unit of FIG. 3 in the present invention can be realized by other circuits. For example, the transmission unit can be realized by a MOSFET. Moreover, the embodiments described in the present invention are capable of being used in other applications. For example, some circuit blocks are enabled when the enable signal is logic low and are disabled when the enable signal is logic high. In this situation the enable signal can be inverted as signal EN in FIG. 3 to generate an accurate gate clock signal. Some circuit blocks include several different enable signals, such as read enable, write enable and etc. A corresponding gate clock signal can be generated according to each enable signal. For example, a block receiving two enable signals works only when both of the enable signals are logic high. In this case, the AND logic operation result of the two enable signals can be as the signal EN in FIG. 3 to generate the gate clock with periodically varying level only when both of the enable signals are high.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A gate clock circuit for generating a gate clock signal, the gate clock circuit comprising:
a transmission unit for receiving an enable signal and a clock signal;
a latch unit coupled to the transmission unit for generating a latch signal; and
an operation unit for processing a logic operation on an inverse of the clock signal and the latch signal to generate a gate clock signal.

2. The gate clock circuit of claim 1, wherein the gate clock signal follows the clock signal when the clock signal is logic high and the latch signal is logic low.

3. The gate clock circuit of claim 1, wherein the transmission unit transmits the enable signal to the latch unit when the clock signal is logic low.

4. The gate clock circuit of claim 3, wherein the latch signal follows the enable signal when the clock signal is logic low.

5. The gate clock circuit of claim 1, wherein the transmission unit does not output the enable signal to the latch unit when the clock signal is logic high.

6. The gate clock circuit of claim 5, wherein the latch signal maintains at fixed logic state when the clock signal is logic high.

7. The gate clock circuit of claim 6, wherein the fixed logic state is the state of the latch signal when the clock signal is logic low.

8. The gate clock circuit of claim 1, wherein the transmission unit is a transmission gate.

9. The gate clock circuit of claim 1, wherein the latch unit comprises two back-to-back inverters.

10. The gate clock circuit of claim 1, wherein the operation unit comprises a NOR gate.

11. The gate clock circuit of claim 1, wherein the operation unit processes a NOR logic operation to generate the gate clock signal.

12. A method of generating a gate clock signal, the method comprising:
receiving an enable signal and a clock signal;
generating a latch signal according to the enable signal and the clock signal; and
processing a logic operation on the latch signal and an inverse of the clock signal to generate a gate clock signal.

13. The method of claim 12, wherein the latch signal follows the enable signal when the clock signal is logic low.

14. The method of claim 12, wherein the latch signal maintains a fixed logic state when the clock signal is logic high.

15. The method of claim 14, wherein the fixed logic state is the state of the latch signal when the clock signal is logic low.

16. The method of claim 12, wherein the latch signal and the inverse clock signal process a NOR logic operation to generate the gate clock signal.

17. The method of claim 12, wherein the gate clock signal follows the clock signal when the clock signal is logic high and the latch signal is logic low.
